(19) United States
(12) Patent Application Publication
(10) Pub. No.: US 2019/0277071 A1
(43) Pub. Date: Sep. 12, 2019

(54) FLAP FOR HANDLESS CLOSURE PANEL IN MOTOR VEHICLES

(71) Applicant: Magna Closures Inc., Newmarket (CA)

(72) Inventors: Gabriele Wayne SABATINI, Keswick (CA); J. R. Scott MITCHELL, Newmarket (CA); James J. FERRI, Maple (CA)

(21) Appl. No.: 16/292,916

(22) Filed: Mar. 5, 2019

Related U.S. Application Data
(60) Provisional application No. 62/639,615, filed on Mar. 7, 2018.

(51) Int. Cl. E05B 85/10; E05F 15/73; B60J 5/04; B60Q 1/32

(52) U.S. Cl. CPC E05B 85/103; E05F 15/73; E05F 1/1215; B60Q 1/323; B60J 5/0468

(57) ABSTRACT

A closure panel system for a motor vehicle comprising: a closure panel mounted to a body of the motor vehicle for movement between a closed position and a fully-open position, the closure panel having an interior surface with at least one of a handle and a door switch mounted on the interior surface adjacent to an edge, the edge defining a transition between the interior surface and an exterior surface of a panel body of the closure panel; and a flap positioned on the motor vehicle adjacent to the edge while being off of and separate to the panel body of the closure panel or mounted on the body panel of the closure panel, the flap covering a recess volume of the motor vehicle adjacent to the least one of the handle and the door switch, such that the least one of the handle and the door switch is accessible via the recess volume once the cover flap is operated; wherein a latch assembly mounted on the handleless closure panel is operated by the at least one of the handle and the door switch.

### CROSS REFERENCE TO RELATED APPLICATION

This application claims priority from U.S. Provisional Patent Application No. 62/639,615, filed on Mar. 7, 2018; the entire contents of which are hereby incorporated by reference herein.

### FIELD

The present disclosure relates generally to door systems for motor vehicles. More particularly, the present disclosure relates to an opening system operable to release and open a vehicle door equipped without an external door handle.

### BACKGROUND

This section provides background information related to door systems for motor vehicles which is not necessarily prior art to the inventive concepts associated with the present disclosure.

In view of increased consumer demand for motor vehicles equipped with advanced comfort and convenience features, many modern motor vehicles are now equipped with passive entry systems to permit locking and release of vehicle doors without the use of traditional key-type manual entry systems. In this regard, some of the more popular features now available include power locking and unlocking, power release, power cinching, and power opening. Most of these “powered” features are typically integrated into a latch assembly mounted to the vehicle door and which is equipped with a latch mechanism and one or more electrical actuators controlling operation of related mechanisms including, for example, a latch release mechanism, a child-lock mechanism and a cinch mechanism. The power door opening feature is commonly provided by a stand-alone power-operated door presenter assembly operable, in coordination with the latch assembly, to move the door from a closed position to a partially-open position so as to subsequently permit the user to manually move the door completely to its fully-open position. Alternatively, the power-operated door presenter assembly can be integrated into the latch assembly.

Typically, the power release feature and subsequent power opening feature have resulted from actuation of a switch or sensor mounted to, or associated with, the outside door handle on the vehicle door following user authentication (i.e. via a key fob). In many arrangements, the user is required to pull on the outside door handle to actuate the power release function. However, attention has recently been directed toward development of “handleless” doors, namely passenger doors without an outside door handle, to provide a more aesthetic and aerodynamic vehicle profile. In such arrangements, a door-mounted release switch, commonly mounted on the applique associated with the vertical pillar section of the door, is actuated by the user to initiate the power release (and power opening if available) function following the user authentication process. This user activation can be with or without physical contact (i.e. microswitch, capacitive switch, IR, IR TOF, LIDAR, radar and/or voice activation, etc.) with respect to the door-mounted release switch.

While current power-operated handleless door systems are sufficient to meet all regulatory requirements and provide the desired levels of comfort and convenience, a need exists to continue development of advanced technology and provide alternative arrangements and features that provide enhanced comfort and convenience to the user.

### SUMMARY

This section provides a general summary of the inventive concepts associated with the present disclosure. Accordingly, this section is not intended to be interpreted as a comprehensive and exhaustive listing of all features, aspects, objectives and/or advantages associated with the inventive concepts which are further described and illustrated in the following detailed description and the appended drawings.

It is an objective of the present disclosure to provide a motor vehicle closure panel system including a closure panel configured without an external handle (hereinafter “the handleless closure panel”) and which is equipped with a latch assembly providing a release/open function.

It is a related objective of the present disclosure to further provide the handleless closure panel with a hidden handle providing an opening function.

It is a further objective of the present disclosure to configure the handleless closure panel as a swing-type passenger-entry door capable of being released via a hidden handle accessed by the user via a flap positioned adjacent to an edge of the door to assist in identifying and grasping an interior surface area of the door for subsequent manual movement from a partially open position into a fully open position or from a closed position to the fully open position.

A first aspect provided is a closure panel system for a motor vehicle comprising: a handleless closure panel mounted to a body of the motor vehicle for movement between a closed position and a fully-open position, the closure panel having an interior surface with at least one of a handle and a door switch mounted on the interior surface adjacent to an edge, the edge defining a transition between the interior surface and an exterior surface of a panel body of the closure panel; and a flap positioned on the motor vehicle adjacent to the edge while being off of and separate to the panel body of the closure panel, the flap covering a recess volume of the motor vehicle adjacent to the least one of the handle and the door switch, such that the least one of the handle and the door switch is accessible via the recess volume once the cover flap is operated; wherein a latch assembly mounted on the handleless closure panel is operated by the at least one of the handle and the door switch.

A second aspect provided is a closure panel system for a motor vehicle comprising: a handleless closure panel mounted to a vehicle body for movement between a closed position and a fully-open position, the closure panel having an interior surface with at least one of a handle and a door switch mounted on the interior surface adjacent to an edge, the edge defining a transition between the interior surface and an exterior surface of a panel body of the closure panel; and a flap positioned on the closure panel adjacent to the edge on the exterior surface, the flap covering a recess volume of the panel body adjacent to the least one of the handle and the door switch, such that the least one of the handle and the door switch is accessible via the recess volume once the cover flap is operated; wherein a latch assembly mounted on the handleless closure panel is operated by the at least one of the handle and the door switch.

A third aspect provided is a method for operating a closure panel system for a handleless closure panel mounted to a motor vehicle for movement between a closed position and a fully-open position, the method comprising the steps of: detecting a user approaching the closure panel; actuating a flap to an open position in order to expose a recess volume to the user, the flap positioned either: a) on the motor vehicle adjacent to an edge of the closure panel while being off of and separate to a panel body of the closure panel; or b) on the closure panel adjacent to the edge on an exterior surface of the closure panel, the flap covering the recess volume adjacent to at least one of a handle and a door switch, such that the at least one of the handle and the door switch is accessible via the recess volume once the cover flap is operated; and operating a latch mechanism of the closure panel based on operation of the at least one of the handle and the door switch.

A fourth aspect provided is a closure panel system for a motor vehicle comprising: a closure panel mounted to a body of the motor vehicle for movement between a closed position and a fully-open position, the closure panel having an interior surface adjacent to an edge, the edge defining a transition between the interior surface and an exterior surface of a panel body of the closure panel; and a flap positioned on the motor vehicle adjacent to the edge while being off of and separate to the panel body of the closure panel, such that the interior surface is accessible once the flap is operated.

A fifth aspect provided is a closure panel system for a motor vehicle comprising: a closure panel mounted to a vehicle body for movement between a closed position and a fully-open position, the closure panel having an interior surface and an edge, the edge defining a transition between the interior surface and an exterior surface of a panel body of the closure panel; and a flap positioned on the closure panel adjacent to the edge on the exterior surface, such that the interior surface is accessible once the cover flap is operated.

### BRIEF DESCRIPTION OF THE DRAWINGS

The drawings described herein are provided to illustrate selected, at least one non-limiting embodiment associated with the present disclosure and are not intended to limit the scope of the present disclosure.

FIG. 1 is a perspective view of a motor vehicle equipped with a closure system embodying the inventive concepts of the present disclosure and including a handleless door equipped with a latch assembly providing a release function accessed via a flap;

FIG. 2 is side view of a further embodiment of the motor vehicle of FIG. 1;

FIG. 3 is a side view of a still further embodiment of the motor vehicle of FIG. 1;

FIG. 4 is a diagram of a control system for a power door actuation system for the motor vehicle of FIG. 1;

FIG. 5 is a side view of operation of the flap of FIG. 3;

FIG. 6 is a cross sectional view of the operation of FIG.5;

FIG. 7A is a partial cutaway view of a vehicle body and a closure panel, with a pivotally mounted flap located on the vehicle body adjacent to an edge of the closure panel, and FIGS. 7B and 7C are views of the interior surface of the flap and vehicle body panel showing the operation of the flap in accordance with an illustrative embodiment;

FIG. 8A is a partial cutaway view of a vehicle body and a closure panel, with a translatable flap located on the vehicle body adjacent to an edge of the closure panel, and FIGS. 8B and 8C are views of the interior surface of the flap and vehicle body panel showing the operation of the flap in accordance with another illustrative embodiment;

FIG. 9 is an illustrative example of an actuator for imparting a movement of the flap;

FIG. 10 shows an alternate embodiment of the motor vehicle of FIG. 1;

FIG. 11 shows a further alternate embodiment of the motor vehicle of FIG. 1;

FIG. 12 shows a cross sectional view of a presentment system of the motor vehicle of FIG. 1 in a closed position;

FIG. 13 shows a cross sectional view of a presentment system of the motor vehicle of FIG. 1 in a presented position;

FIG. 14 shows a still further alternate embodiment of the motor vehicle of FIG. 1;

FIG. 15a, 15b, 15c show an operational example of the flap of the motor vehicle of FIG. 1;

FIG. 16a, 16b, 16c show an alternate operational example of the flap of the motor vehicle of FIG. 1; and

FIG. 17 is a flowchart of a still further operational example of the flap of FIG. 1.

Corresponding reference numerals are used to indicate corresponding components throughout the several views of the drawings.

### DETAILED DESCRIPTION

Example embodiments will now be described more fully with reference to the accompanying drawings. To this end, the example embodiments are provided so that this disclosure will be thorough, and will fully convey its intended scope to those who are skilled in the art. Accordingly, numerous specific details are set forth such as examples of specific components, devices, and methods, to provide a thorough understanding of embodiments of the present disclosure. However, it will be apparent to those skilled in the art that specific details need not be employed, that example embodiments may be embodied in many different forms, and that neither should be construed to limit the scope of the present disclosure. In some example embodiments, well-known processes, well-known device structures, and well-known technologies are not described in detail.

In the following detailed description, the expression “latch assembly” will be used to generally, as an illustrative example, indicate any power-operated latch device adapted for use with a vehicle closure panel to provide at least a power release feature. Additionally, the expression “closure panel” will be used to indicate any element moveable between an open position and at least one closed position, respectively opening and closing an access to an inner compartment of a motor vehicle and therefore includes, without limitations, decklids, tailgates, liftgates, bonnet lids, and sunroofs in addition to the sliding or pivoting side passenger doors of a motor vehicle to which the following description will make explicit reference, purely by way of example. Furthermore, the expression “presentment mechanism” will be used to generally indicate any power-operated presenter device adapted for use with a vehicle closure panel to provide a power opening feature capable of moving the vehicle closure panel between a closed position and an open position, preferably a partially-open position, with respect to the body of the motor vehicle. The expression “handleless” will be used in conjunction with vehicle closure panel to indicate such a closure panel configured without an external (i.e. outside) handle.

Vehicle closure systems, particularly related to vehicle closure panels of the passenger-entry type, are evolving toward fully automated door opening and door closing solutions requiring less interaction with the user to open and close the vehicle door. One such system involves “presenting” the door to the user as he/she approaches the motor vehicle. This presenting function involves initially unlatching a latch assembly associated with the door and subsequently moving the door from a closed position to a partially-opened position so the user can subsequently manually move the door to a fully-open position, typically by grabbing the outside door handle. Still in other systems, a power release mechanism associated with the latch assembly can be actuated to unlatch the latch assembly upon an unlock command being received by a latch controller in response to activation of the outside door handle. For closure systems associated with doors configured without an outside door handle (i.e. a handleless door), for example those equipped with a touch or touchless type of keypad, or fob-based authentication system, which replace the “manual pull” handle unlatch function with an electronic touch or swipe function, the handleless door may be unlatched but the user cannot grasp the door handle to further move the door to its fully-open position. Instead, the user must reach their fingers between the edge of the door and the vehicle body and pull manually on the door itself. When users first encounter handleless door systems, they may not be aware that they must physically grasp the door to further open the door. Certain areas along the door edge can be outfitted with, or configured to include, a grasping area having a rubber grip pad to designate the preferred grasp area of the handleless door. Adequate space for providing the user with ease of grasping and opening a handleless door is desired. Further, adequate indication of where on the handleless door and interior handle/switch and/or grasp region is located on the handleless door providing the user with ease of grasping and opening a handleless door is desired.

The inventive concepts of the present disclosure, to be hereinafter described in greater detail, are directed to providing the user with a means of accessing an appropriate grasp area and/or handle/switch positioned on an interior surface of the handleless door, along the door edge of the handleless door. This means is provided by a flap positioned on an exterior surface (e.g. of the handleless door itself, on an adjacent door, on an adjacent body portion of the vehicle) adjacent to the edge (i.e. perimeter) of the handleless door. The location of the flap is aligned with and/or in close proximity to the grasp area and/or handle/switch and therefore can provide the user with accessibility to the grasp area and/or handle/switch for opening the desired door, e.g. once the door has been deployed to its partially-open position by the presenter mechanism. This solution may, in accordance with a non-limiting embodiment, provide a method of unlocking the handleless door using the power release function of the latch assembly and deploying the door from its closed/unlatched position to its partially-open position using the power opening function of the presenter assembly.

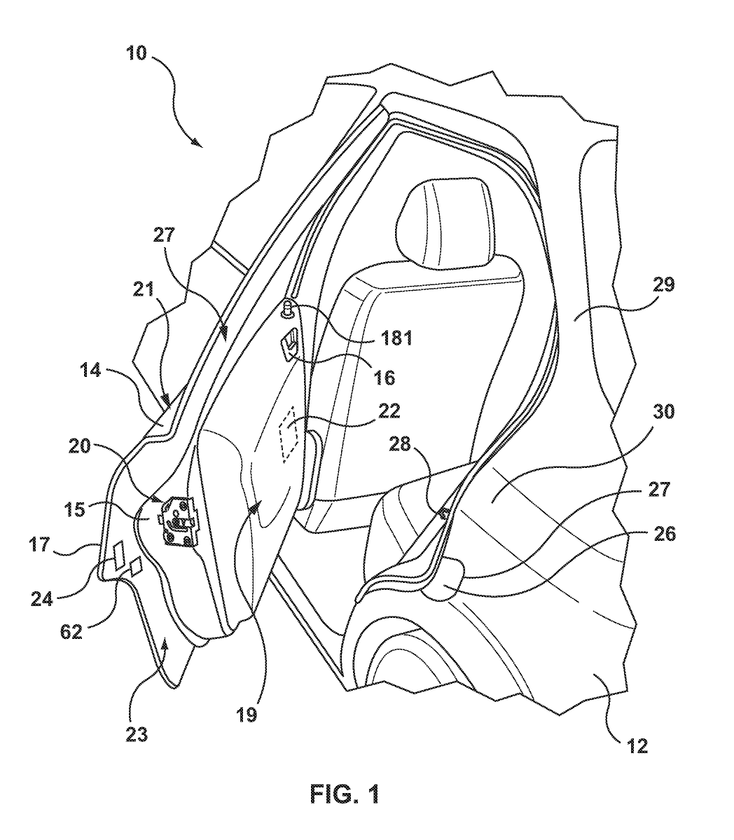

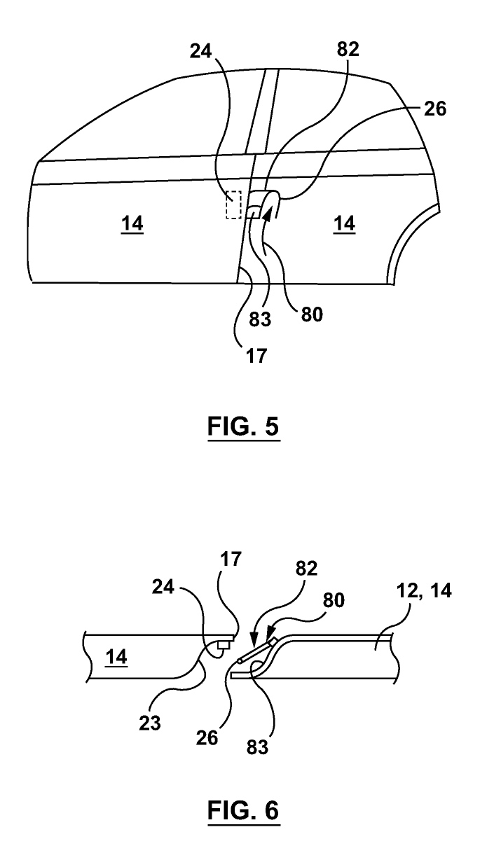

FIG. 1 is a perspective view of a vehicle 10 that includes a vehicle body 12 and at least one vehicle door 14 (also referred to as closure panel 14). The vehicle door 14 includes a latch assembly 20 that is positioned on an edge face 15 and which is releasably engageable with a striker 28 on the vehicle body 12 to releasably hold the vehicle door 14 in a closed position. The closure panel 14 is configured as a handless door such that the closure panel 14 does not have an outside door handle. An inside handle 16 can be provided for opening the latch assembly 20 (i.e. for releasing the latch assembly 20 from the striker 28) to open the vehicle door 14 by a user from inside of the vehicle 10. An optional lock knob 181 is shown and provides a visual indication of the lock state of the latch assembly 20 and may be operable to change the lock state between an unlocked position and a locked position. It is recognized that the closure panel 14 is positioned adjacent to pillar 29 when closed, such that a hand of the vehicle user (e.g. driver) is generally inhibited from insertion between the pillar 29 and the closure panel 14. The pillar 29 is one example of the vehicle body 12 adjacent to an edge 17 of the closure panel 14, such that the edge 17 of the closure panel is on the periphery of the closure panel 14. The edge 17 is positioned between an outside surface 21 of the closure panel 14 and an inside surface 23. As such, it is shown that the flap 26 (covering the recess volume 83—see FIGS. 5, 6) can be aligned with the area (e.g. on the closure panel 14) providing the handle 24 and/or door switch 62.

It is recognized that the latch assembly 20 can be configured as any type of latch (e.g. manual release, power release, with or without cinch functionality, etc.). The latch assembly 20 can have a presentment mechanism 22 (e.g. presenter assembly 22) as latch components mounted on the latch housing (e.g. within the housing interior). Further, the latch assembly 20 can also have an optional feature of using a common actuator (e.g. electric motor) to operate both the presentment mechanism 22 and other latch components (e.g. ratchet) to provide for a cinching operation (i.e. soft close).

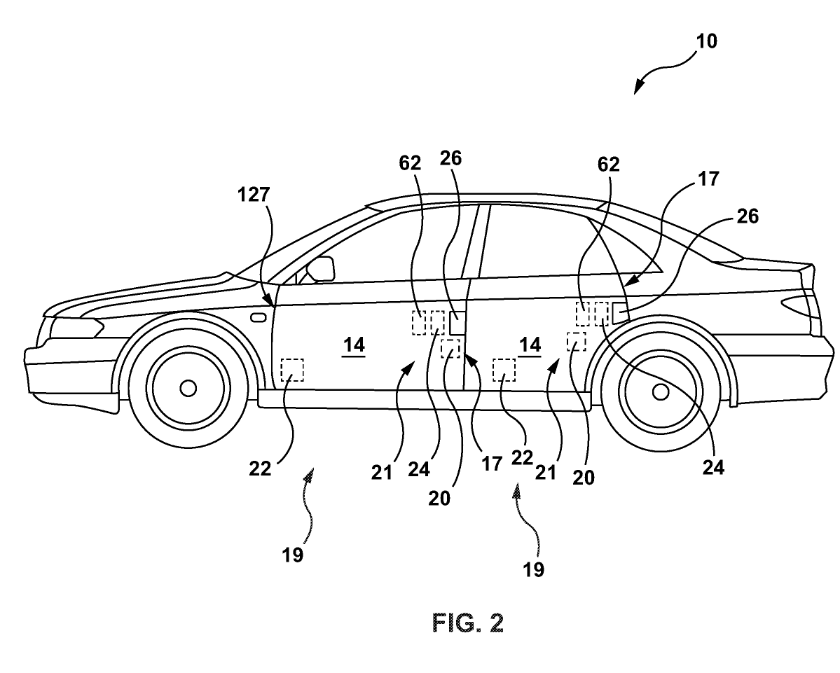

Referring again to FIGS. 1 and 2, positioned on the inside surface 23 is a handle 24 for use by the vehicle user when external to the interior of the vehicle 10, i.e. outside of the vehicle 10. The handle 24 can be used by the user to open the closure panel 14 from a closed (or presented) position to an open position. The handle 24 is accessible by the user via operation of a flap 26, which can be configured to pivot about a hinge 127 (either outwards or inwards from an exterior body surface 30) in order to provide access to fingers of the user to the handle 24 mounted on the inside surface 23 of the closure panel 14. As such, the flap 26 can be positioned on the vehicle body 12, rather than on the closure panel 14 itself, and adjacent to the edge 17 of the closure panel 14 in the vicinity of the handle 24. Accordingly, once the flap 26 is opened (e.g. pivoted inwards from the exterior body surface 30), the user can insert their fingers around the edge 17 and behind the interior surface 23 in order to actuate the handle 24 and/or grasp the interior surface 23 in order to open the closure panel 14. The edge 17 defines a transition between the interior surface 23 and an exterior surface 21 of a panel body 27 of the closure panel 14.

Further, or in addition to the handle 24, the closure panel 14 can also have a door switch 62 positioned on the interior surface 23 for use by the vehicle user when external to the interior of the vehicle 10, i.e. outside of the vehicle 10. The door switch 62 can be used by the user to open the closure panel 14 from a closed (or presented) position to an open position. The door switch 62 is accessible by the user via operation of the flap 26, which can be configured to pivot about the hinge 127 (either outwards or inwards from an exterior body surface 30) in order to provide access to fingers of the user to the door switch 62 mounted on the inside surface 23 of the closure panel 14. As such, the flap 26 can be positioned on the vehicle body 12, rather than on the closure panel 14 itself, and adjacent to the edge 17 of the closure panel 14 in the vicinity of the door switch 62. Accordingly, once the flap 26 is opened (e.g. pivoted inwards from the exterior body surface 30), the user can insert their fingers around the edge 17 and behind the interior surface 23 in order to actuate the door switch 62 and/or grasp the interior surface 23 in order to open the closure panel 14.

Referring to FIG. 2, shown is further embodiment of the flap 26, such that the flap 26 is positioned on the exterior surface 21 of the closure panel 14 itself and also adjacent to the edge 17. Similar to the embodiment of FIG. 1, once the flap 26 is operated (e.g. swung inwards or outwards with respect to the exterior surface 21, the user would gain access to the handle 24 or door switch 62 (shown in ghosted view) mounted on the interior surface 23 of the closure panel 14 (see FIG. 1).

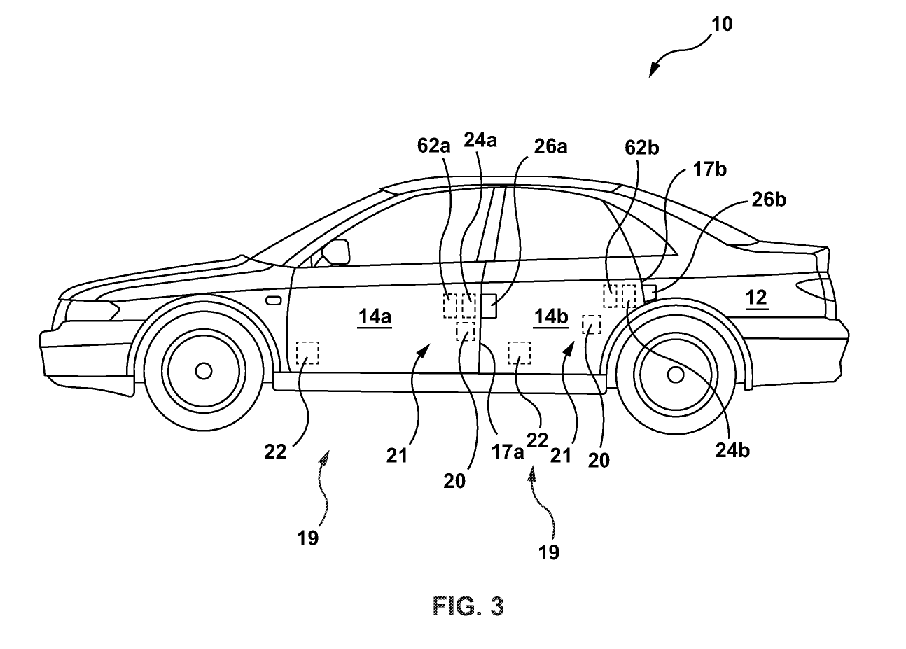

Referring to FIG. 3, shown is a further embodiment of a flap 26a,b, such that the flap 26a,b is mounted on the exterior surface 21 (or the vehicle body 12) that is both adjacent to a respective closure panel 14a,b as well as adjacent to a respective edge 17a,b of the closure panel 14a,b. For example, the front closure panel 14a has the flap 26a mounted on the rear closure panel 14b, such that operation of the flap 26a provides for access to a handle 24a or a door switch 62a controlling opening of the closure panel 14a. Similarly, the rear closure panel 14b has the flap 26b mounted on the vehicle body 12, such that operation of the flap 26b provides for access to a handle 24b or a door switch 62b controlling opening of the closure panel 14b.

Referring again to FIG. 1, the closure panel 14 (e.g. occupant ingress or egress controlling panels such as but not limited to vehicle doors and lift gates/hatches) is connected to the vehicle body 12 via one or more hinges (not shown) and the latch assembly 20 (e.g. for retaining the closure panel 14 in a closed position once closed). It is also recognized that the hinge can be configured as a biased hinge that can be configured to bias the closure panel 14 towards the open position and/or towards the closed position. In terms of a biased hinge used in combination with the latch assembly, the biased hinge can provide for assistance in presenting the closure panel 14 beyond where a ratchet of the latch assembly 20 can influence positioning of the closure panel 14 (i.e. via operation of presentment members of the presentment mechanism). It is also recognized that the biased hinge can be configured as a door check mechanism integrated into the hinge and/or an independent door check assembly providing the bias. The closure panel 14 can have the striker 28 (e.g. mating latch component) mounted thereon for coupling with a respective latch assembly 20 (e.g. with the ratchet component of the latch assembly 20) mounted on the vehicle body 12. Alternative to that shown in FIG. 1, the latch assembly 20 can be mounted on the body 12 and the striker 28 can be mounted on the closure panel 14.

Referring to FIGS. 1, 2 and 3, closure panels 14, 14a,b are shown to be configured without outside door handles so as to each define a “handleless” closure panel 14, 14a,b that is part of a power door actuation system 19 for the vehicle 10.

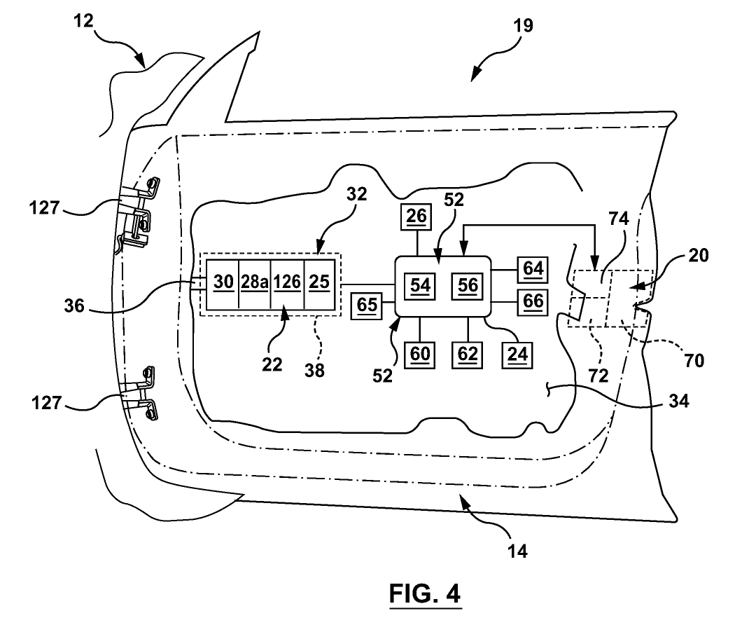

Power door actuation system 19 is shown schematically in FIG. 4 to include a latch assembly 20 and a presenter assembly 22. Latch assembly 20 is mounted to closure panel 14 and includes (in this non-limiting configuration) a latch mechanism (e.g. ratchet and pawl configuration in association with the striker 28—see FIG. 1), a power-operated latch release mechanism, and a power-operated lock mechanism. Latch assembly 20 is defined to be operating in a locked-latched mode when the latch mechanism is latched and the lock mechanism is locked for holding closure panel 14 in a locked-closed position. Latch assembly 20 is also defined to be operating in an unlocked-latched mode when the latch mechanism is latched and the lock mechanism is unlocked for holding closure panel 14 in an unlocked-closed position. Finally, latch assembly 20 is defined to be operating in an unlatched mode when the latch mechanism is released and the lock mechanism is unlocked so as to permit movement of closure panel 14 from its unlocked-closed position toward a fully-open position. At least one electrically-powered latch actuator is provided in association with latch assembly 20 for controlling operation of the latch release and lock mechanism to provide a power release function and a power lock function. An activation command signal generated by an authentication device is used by a latch controller to initiate operation of the electric latch actuator to provide the desired power release and power lock functions. The authentication device is associated with a passive keyless entry system and may include, without limitation, a key fob, a contact or non-contact interface provided on closure panel 14, and a voice recognition interface. The specific details of latch assembly 20 and its activation protocol are not required as those skilled in the art understand the provisions of the power release and power lock functionality discussed above.

Power door actuation system 19 is diagrammatically shown in FIG. 4 to include a power swing door actuator 32 comprised of an electric motor 25, a reduction geartrain 126, a slip clutch 28a , and a drive mechanism 30 which together define (e.g. powered door) presenter assembly 22 that is mounted within an interior chamber 34 of closure panel 14. Examples of presenter assemblies are shown in commonly-owned U.S. application Ser. No. 15/473,713, titled “Power Swing Door Actuator With Articulating Linkage Mechanism”, the entire application being incorporated by reference herein. Presenter assembly 22 also includes a connector mechanism 36 configured to connect an extensible member of drive mechanism 30 to a portion of vehicle body 12. Presenter assembly 22 further includes a support structure, such as an actuator housing 38, configured to be secured to closure panel 14 within chamber 34 and to enclose electric motor 25, reduction gear train 126, slip clutch 28a and drive mechanism 30 therein. As also shown, an electronic control module 52 is in communication with electric motor 25 for providing electric control signals thereto. Electronic control module 52 may include a microprocessor 54 and a memory 56 having executable computer readable instructions stored thereon. Electronic control module 52 can be integrated into, or directly connected to, actuator housing 38 or may be a remotely located device within door chamber 34.

Although not expressly illustrated, electric motor 25 can include Hall-effect sensors for monitoring a position and speed of closure panel 14 during movement between its open and closed positions. For example, one or more Hall-effect sensors may be provided and positioned to send signals to electronic control module 52 that are indicative of rotational movement of electric motor 25 and indicative of the rotational speed of electric motor 25, e.g., based on counting signals from the Hall-effect sensor detecting a target on a motor output shaft. In situations where the sensed motor speed is greater than a threshold speed and where the current sensor registers a significant change in the current draw, electronic control module 52 can determine that the user is manually moving closure panel 14 while the electric motor 25 is also operating, thus moving closure panel 14. Electronic control module 52 can then send a signal to the electric motor 25 to stop the electric motor 25 and can even disengage slip clutch 28a (if provided). Conversely, when electronic control module 52 is in a power open or power close mode and the Hall-effect sensors indicate that a speed of electric motor 25 is less than a threshold speed (e.g., zero) and a current spike is registered, electronic control module 52 may determine that an obstacle is in the way of closure panel 14, in which case the electronic control system may take any suitable action, such as sending a signal to turn off the electric motor 25. As such, electronic control module 52 receives feedback from the Hall-effect sensors to ensure that a contact obstacle has not occurred during movement of closure panel 14 from the closed position to the partially-open position, or vice versa.

As is also schematically shown in FIG. 4, the electronic control module 52 can be in communication with a remote key fob 60 and/or with the handle 24 and/or the door-mounted switch 62 for receiving a request from a user (when external to the vehicle 10) to open or close closure panel 14. Put another way, the electronic control module 52 receives a command signal from either remote key fob 60 and/or door switch 62 and/or handle 24 to initiate (or complete) an opening or closing of closure panel 14. Upon receiving a command, electronic control module 52 proceeds to provide a signal to the electric motor 25 in the form of a pulse width modulated voltage (for speed control) to turn on the electric motor 25 and initiate pivotal swinging movement of closure panel 14. While providing the signal, the electronic control module 52 can also obtain feedback from the Hall-effect sensors of the electric motor 25 to provide that a contact obstacle has not occurred. If no obstacle is present, the motor 25 will continue to generate a rotational force to actuate the (e.g. spindle) drive mechanism 30. Once closure panel 14 is positioned at the desired location, the electric motor 25 is turned off and the “self-locking” gearing associated with the reduction gear train 126 causes closure panel 14 to continue to be held at that location, thereby providing an automatic door checking function. If a user tries to move closure panel 14 to a different operating position, the electric motor 25 can first resist the user's motion (thereby replicating a door check function) and eventually release and allow closure panel 14 to move to the newly desired location. Again, once closure panel 14 is stopped, the electronic control module 52 can provide the required power to the electric motor 25 to hold it in that position. If the user provides a sufficiently large motion input to closure panel 14 (i.e., as is the case when the user wants to close the door), the electronic control module 52 can recognize this motion via the Hall effect pulses and proceed to execute a full closing operation for the closure panel 14.

It is also recognized that the flap 26 can be manually operated (e.g. opened, closed) or could be electronically operated, for example via the key fob 60 or other presence/pressure sensor positioned or otherwise associated with the flap 26. For example, the user could press a flap button on the key fob 60, which would signal the control module 52 to open the flap 26 (e.g. unlock a flap latch retaining the flap in a closed position as flush with the exterior surface 21—see FIG. 1). Alternatively, the user could position their hand adjacent to the flap 26 (or otherwise push on the flap 26), which would signal the control module 52 to open the flap 26.

Electronic control module 52 can also receive an additional input from an ultrasonic sensor 64 positioned on a portion of closure panel 14, such as on a door mirror or the like. Ultrasonic sensor 64 assesses if an obstacle, such as another car, tree, or post, is near or in close proximity to closure panel 14. If such an obstacle is present, ultrasonic sensor 64 will send a signal to electronic control module 52 and electronic control module 52 will proceed to turn off electric motor 25 to stop movement of closure panel 14, thereby preventing closure panel 14 from hitting the obstacle. This provides a non-contact obstacle avoidance system. In addition, or optionally, a contact obstacle avoidance system can be placed in vehicle 10 which includes a contact sensor 66 mounted to closure panel 14, and which is operable to send a signal to the electronic control module 52.

Power door actuation system 19 is also shown schematically in FIG. 4 with a further embodiment of the latch assembly 20 having a latch mechanism 70, a latch release mechanism 72, and a power-operated release actuator such as an electric power release motor 74. For purposes of illustration only the electronic control module 52 is shown in communication with electric power release motor 74 so as to also act as a latch controller for controlling operation of latch assembly 20. The electronic control module 52 can be an integrated configuration or a pair of distinct controllers associated with presenter assembly 22 and latch assembly 20. Key fob 60 and/or handle 24 and/or door switch 62 are again used to authenticate the user and control the power release (and power lock) function.

Referring to FIG. 5, shown is a side view of the flap 26 positioned adjacent to the edge 17 of the closure panel 14, such that the flap 26 is external to the closure panel 14 and thus is not mounted on the closure panel 14. Once the flap 26 is operated (e.g. pushed 80 as shown by example) manually by the user, or otherwise automatically by the electronic control module 52 (see FIG. 4), an opening 82 is revealed proving access to a recess volume 83 (e.g. pocket) located behind the flap 26. It is noted that the recess volume 83 is also located adjacent to the edge 17, thus providing access by the user to the interior surface 23 of the closure panel 14 adjacent to the edge 17 and thus the handle 24 (or door switch 62—see FIG. 1). Referring to FIG. 6, shown is a cross sectional view of the flap 26 operation, such that the user gains access to the handle 24 (or door switch 62) of the closure panel 14 via the recess volume 83 exposed via operation of the flap 26 (e.g. push) in the vehicle body 12 (or other closure panel 14) adjacent to the edge 17 of the closure panel 14 to be opened by the user in subsequent operation of the handle 24 (or door switch 62). In other words, once the user gains access to the recess volume 83 via the flap 26 adjacent to the edge 17 of the closure panel 14, the user can reach the interior surface 23 of the closure panel 14 also adjacent to the edge 17 and thus operate the handle 24 (or door switch) mounted on the interior surface 23 of the closure panel 14. Once the handle 24 (or door switch 62) is operated by the user, the closure panel 14 is opened.

As such, referring to FIG. 1, the closure system for the motor vehicle 10 includes the handleless closure panel 14 (e.g. pivotably) mounted to the vehicle body 12 for movement between a closed position and a fully-open position, the closure panel 14 having the interior surface 23 with at least one of the handle 24 and the door switch 62 mounted on the interior surface 23 adjacent to the edge 17, the edge 17 defining a transition between the interior surface 23 and the exterior surface 21 of the panel body 27 of the closure panel 14. The latch assembly 20 is mounted to the handleless closure panel 14 and can be equipped with a latch mechanism and a latch release, such that the handle 24 and/or the door switch 62 is used by the vehicle user to operate the latch assembly 20. The flap 26 is positioned on the motor vehicle 10 adjacent to the edge 17 (for example while being off of and separate to the panel body 27), the flap 26 covering the recess volume 83 of the motor vehicle 10 adjacent to the least one of the handle 24 and the door switch 62, such that the least one of the handle 24 and the door switch 62 is accessible via the recess volume 83.

Referring to FIGS. 1 and 5, in operation of the power door actuation system 19, the user operates the flap 26 (e.g. manually by pushing 80 or automatically) adjacent to the edge 17 of the closure panel 14 in order to reveal the handle 24 (or door switch 62) mounted on the interior surface 23 of the closure panel 14 adjacent to the edge 17 of the closure panel 14. It is recognized that the position of the handle 24 (or door switch 62) on the interior surface 23 can be directly behind the flap 26 or otherwise adjacent to the opening 82.

In view of the above, the flap 26 for covering the handle 24 (e.g. door handle) and/or door switch 62 is considered different than known prior art flap configurations, as both the flap 26 and the handle 24/door switch 62 of the present invention are both located adjacent to the perimeter (i.e. adjacent to the edge 17) of the closure panel 14. This proximity to the edge 17 is realized both for the embodiments of the flap 26 being on, or off of, the closure panel 14. As is shown in FIG. 1 by example, the flap 26 is located adjacent to the edge 17, or even adjacent to the closure panel 14 on the vehicle body 12 to allow access to the handle 24 mechanism/ or grasping surface (interior surface 23) also located about the edge 17 of the closure panel 14. The embodiments of the flap 26 position the flap 26 on a body not being the closure panel 14 (e.g. vehicle body 12 and/or another closure panel 14), as well as located on the closure panel 14 itself to expose the handle 24 (or door switch 62) adjacent to the edge 17 of the closure panel 14. In the embodiments shown, the flap 26 extends inwards (i.e. from the exterior surface 21 to the interior surface 23), but the flap 26 could also extend outwardly. The flap 26 can be actuated upon approach for example which would help the user visually locate the handle 24 on the handless closure panel 14, or manually moved by a user's fingers.

It is recognized that the flap 26 can be utilized in conjunction with the handle 24 positioned on the interior surface 23 adjacent to the door edge 17, where the user can grasp once the handle 24/door switch 62 has been actuated by the user. As such, the interior surface 23 can be used as a grasp surface for moving the closure panel 14 from the closed/partially open position to the fully open position. It is envisioned the flap 26 facilitates to give the user's fingers more room to grasp the door edge 17, or it could also be the case where a user has to actuate a lever of the handle 24 on the door edge.

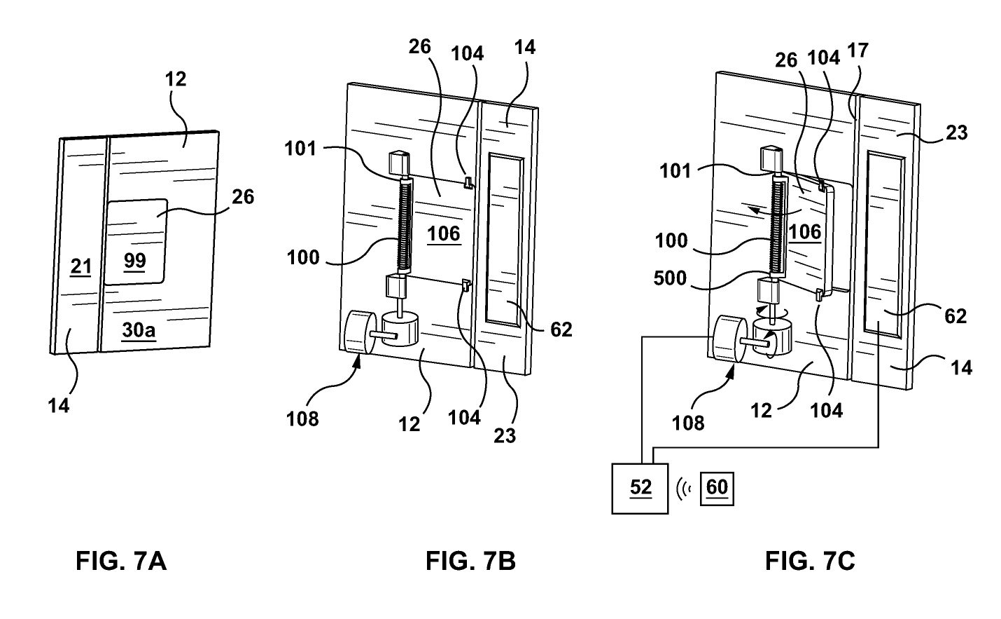

Now referring to FIG. 7A to 7C, there is illustrated another embodiment of the flap 26 and its pivoting operation via a manual activation. FIG. 7A illustrates the flap 26 in its closed position with the flap 26 exterior flap surface 99 flush with the exterior body surface 30a of the body 12 and the exterior surface 21 of the closure panel 14. This is the initial orientation presented to the user. FIG. 7B illustrates a torsion spring 100 about a hinge 101 connecting 500 the flap 26 to the vehicle body 12 used to apply continual closing force to the flap 26 keeping the flap 26 flush with the exterior body surface 30a. For example, an actuator assembly 108 can be coupled to the hinge 101, which can be operated by the electronic control module 52 in order to overcome the bias of the torsion spring 100 to provide for automated opening of the flap 26. Additionally rotational stops 104 projecting from the flap interior surface 106 are integrated into the flap 26 to limit over rotation. Accordingly, changes to the pivot point of the hinge 101 can provide for additional rotation options of the flap 26 with respect to the closure panel 14. When access to the (e.g. latch release) door switch 62 or the interior surface 23 is required, pressure is placed on the side of the flap 26 opposite to hinge 101. This physical interaction overcomes the force of the torsion spring 100 allowing for the flap 26 to pivot within the recess volume 83. The user then may insert his fingers to be able to actuate the door switch 62 and/or grasp the interior surface 23.

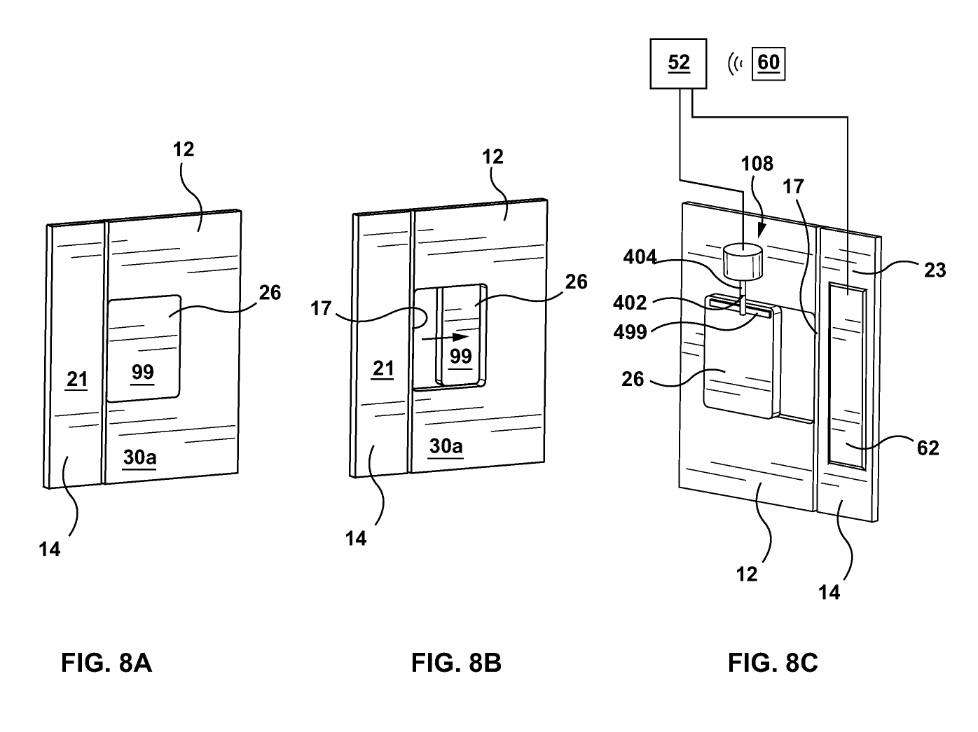

Now referring to FIG. 8A to 8C, there is illustrated another embodiment of the flap 26 and its sliding operation via a powered activation. FIG. 8A illustrates the flap 26 in its closed position with the exterior flap surface 99 flush with the exterior body surface 30a and the exterior surface 21. This is the initial orientation presented to the user. FIG. 8B illustrates the flap 26 in a mid-translation or sliding position away from the edge 17 of the closure panel 14. When access to the latch release door switch 62 or the interior surface 23 is required, an actuator assembly 108 operably connected via a mechanism, such as a rack 501 connected to the flap 26 and a pinion gear 402 operably connected to an output shaft 404 of the actuator assembly 108 can be operated to translate upon activation of the key fob 60 requesting unlocking and/or unlatching of the closure panel 14 with the electronic control module 52. Once the flap 26 has been translated to expose the recess volume 83, the user can insert his fingers to be able to actuate the door switch 62 and/or grasp the interior surface 23.

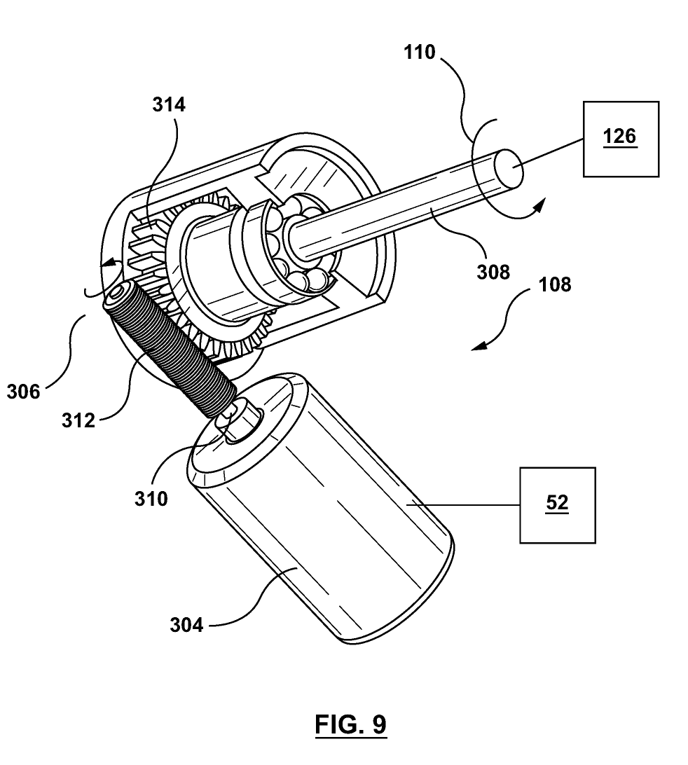

Now referring to FIG. 9, there is provided an illustrative embodiment of the actuator assembly 108 having an output 110 for imparting a moving force on the flap 26 for moving the flap 26 between the closed and open positions (see FIGS. 7C and 8C by example). The actuator assembly 108 is shown to generally include an electric motor 304, a worm gearset 306, and a power screw 308. Electric motor 304 includes a rotary output shaft 310 to which a worm 312 of the worm gearset 306 is fixed for common rotation. A worm gearwheel 314 of worm gearset 306 is in constant meshed engagement with worm 312. The power screw 308 is operably connected to the worm gearwheel 314 such that a rotation of the worm gearwheel 314 imparts a corresponding rotation of the power screw 308. The power screw 308 can be coupled to the flap for moving the flap 26 in a number of manners. In one example the power screw can be coupled to a strap portion 499 (see FIG. 8C) mounted to the flap 26 forming part of the hinge 101. A rotation of the power screw 308 will cause rotation of the flap 26. The actuator assembly 108 can be mounted to the body 12 within the volume recess 83 for example.

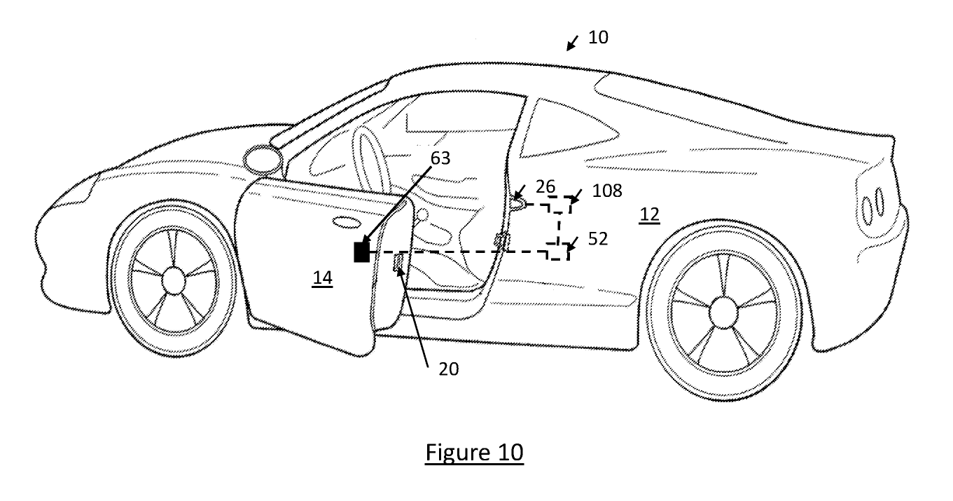

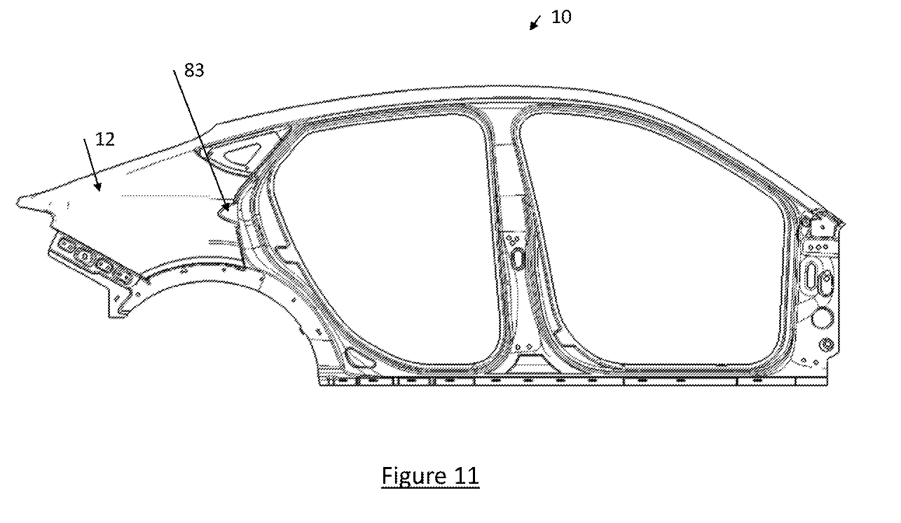

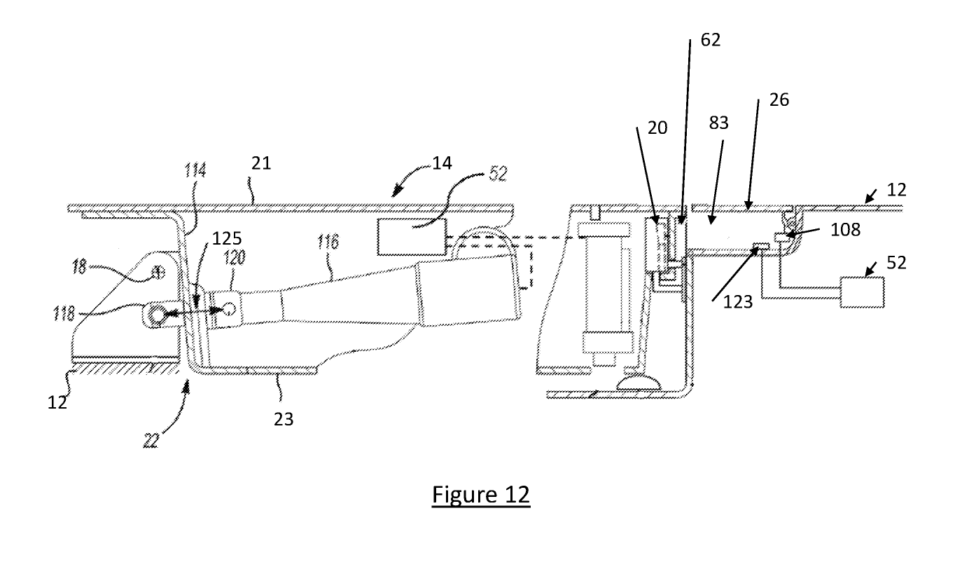

Referring to FIG. 10, shown is an example in which the actuator assembly 108 is coupled to the flap 26, as operated by the electronic control module 52. The electronic control module 52 can be connected to a proximity sensor 63, for example, in order to signal the electronic control module 52 to operate the actuator assembly 108 (and thus the flap 26) in the presence of the user of the vehicle 10. FIG. 11 shows the body 12 of the vehicle 10 having an example recess volume 83 positioned adjacent to the location of the closure panel 14 (not shown).

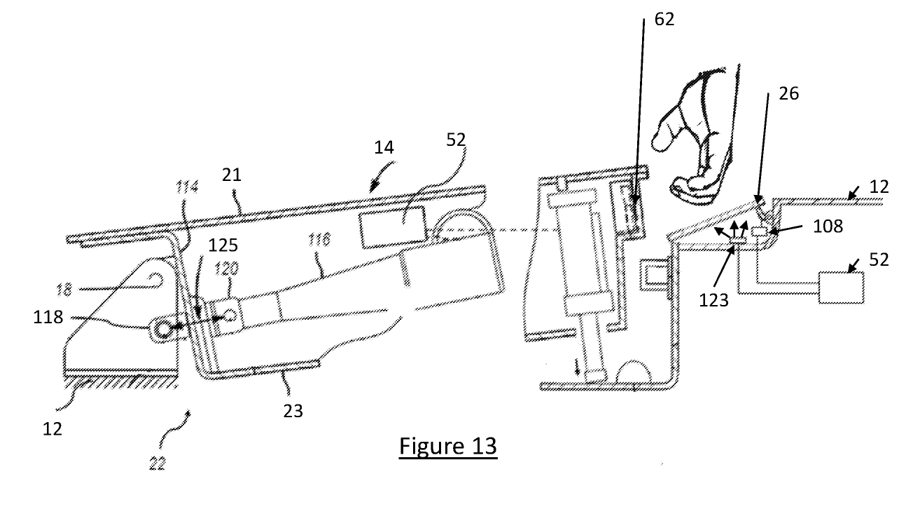

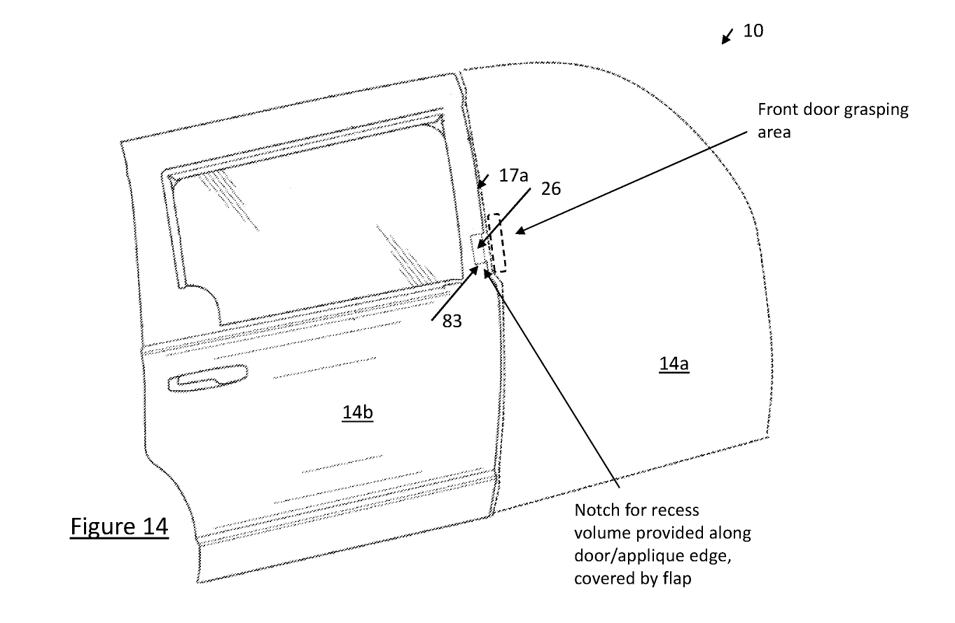

Referring to FIG. 12, shown is an example embodiment of the presentment mechanism 22. The (e.g. power-operated) presentment mechanism 22 has a housing 116 and an extensible member 118. The extensible member 118 is moveable between extended and retracted positions relative to housing 116. The presentment mechanism 22 can be mounted between the inner and outer sheet metal panels (e.g. inner surface 23 and outer surface 21), in a lengthwise orientation, where the actuator housing 116 is fixed (e.g. permanently fixed, for example using bolts or other fastener types) to the closure panel 14 via a bracket 120 mounted to a connecting door portion 114. The closure panel 14 is connected to the body 12 via one or more hinges 18. As shown in FIG. 13, as the presentment mechanism 22 is operated the extensible member 118 extends 125 and thus the closure panel 14 pivots about the hinge 18.

As further shown in FIGS. 12,13, a light source 123 (e.g. LED) can be mounted in the recess volume 83 in order to illuminate the recess volume 83 when the flap 26 is opened in order to help alert the approaching user of the flap 26 location. As such, the electronic control module 52 can be used to actuate the light source 123 and/or the flap 26 itself (e.g. via the actuator assembly 108).

Referring to FIG. 14, shown is an embodiment in which the recess volume 83 is positioned underneath the flap 26 positioned on the closure panel 14b adjacent to the closure panel 14a, such that the closure panel 14a has the handle 24 or door switch 62 positioned adjacent to its edge 17a, opposite to the flap 26 positioned on the closure panel 14b.

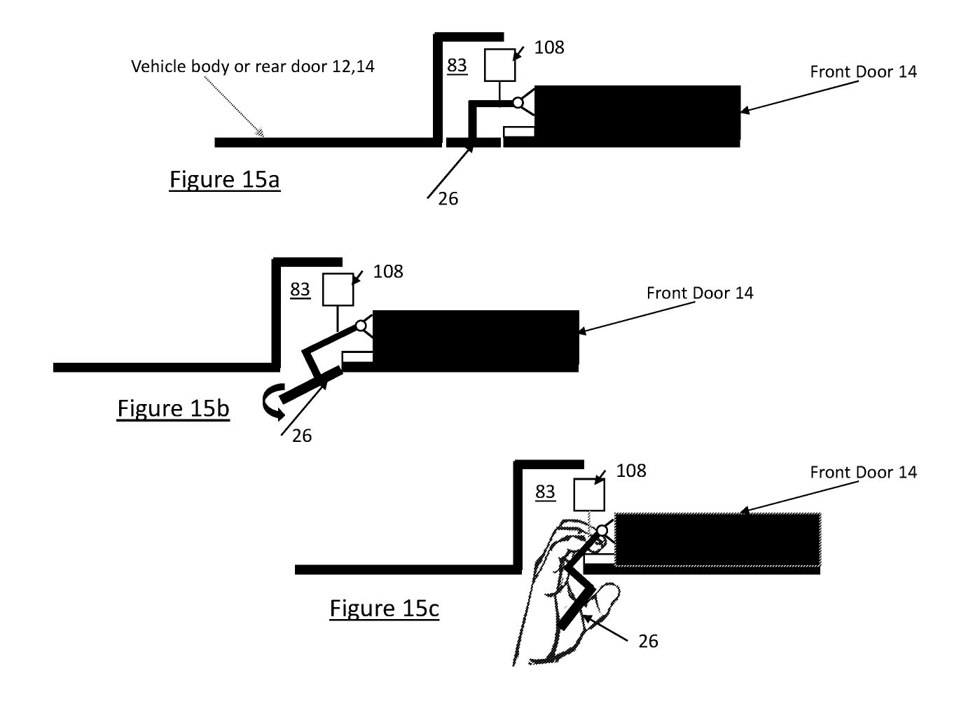

Referring to FIGS. 15a,b,c, shown is an example operation of an actuated version of the flap 26, such that the actuator assembly 108 is used to open the flap 26 from the closed position of FIG. 15a to the open position of FIG. 15b. Once in the open position (of FIG. 15b), the user can then grasp the flap 26 (and further open the flap 26 as desired) in order to access the recess volume 83 in order to actuate the door handle 24 and/or door switch 62.

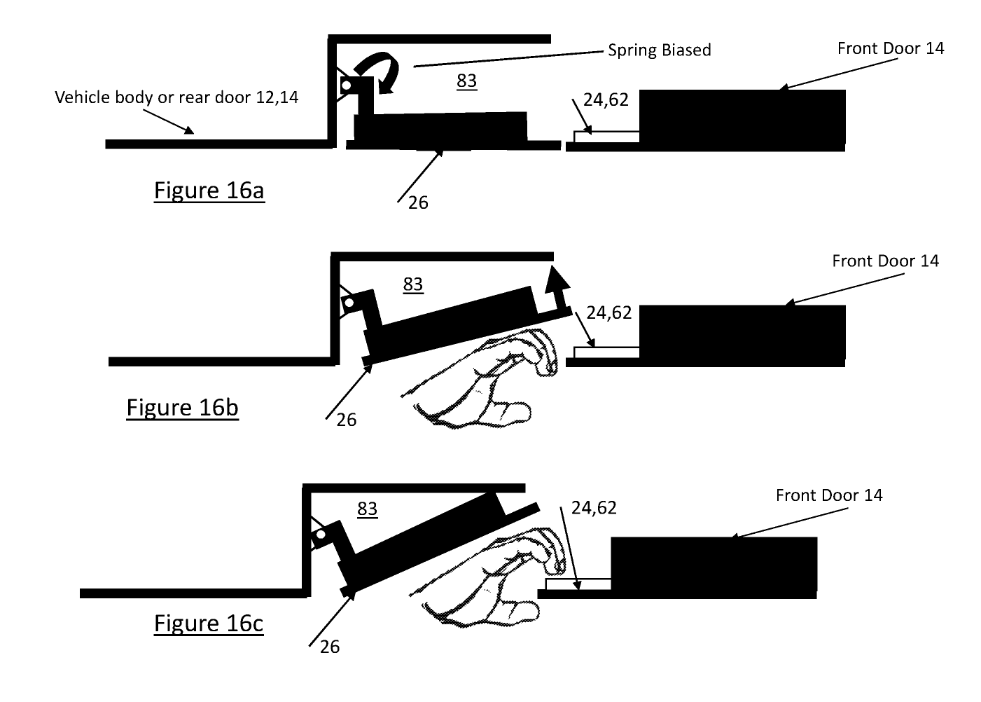

Referring to FIGS. 16a,b,c, shown is an example operation of a non-powered version of the flap 26, such that the user pushes open the flap 26 from the closed position of FIG. 16a to the open position of FIG. 16b. Once in the open position (of FIG. 16b), the user can then further move the flap 26 (optional) in order to access the recess volume 83 in order to actuate the door handle 24 and/or door switch 62 contained therein.

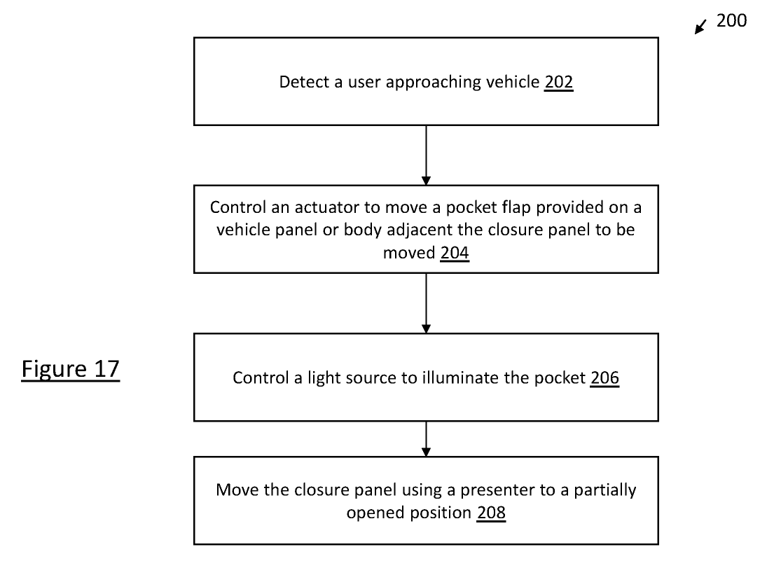

Referring to FIGS. 1, 4 and 17, shown is an example operation 200 of the flap 26. At step 202, the electronic control module 52 detects (e.g. via a proximity sensor) that the user approaches the closure panel 14. At step 204, the actuator assembly 108 (see FIGS. 7C, 8C) actuates the flap 26 in from a closed position to an open position (e.g. via pivoting or sliding) in order to expose the recess volume 83 to the user. At step 204, optionally, a light source 123 can be operated by the electronic control module 52 in order to illuminate the recess volume 83. At step 206, the user can access the door handle 24 and/or door switch 62 in order to operate the latch assembly 20. At step 208, optionally the electronic control module 52 can operate the presentment mechanism 22 in order to present the closure panel 14 to the user.

What is claimed is:

1. A closure panel system for a motor vehicle (10) comprising:
a closure panel (14) mounted to a body (12) of the motor vehicle for movement between a closed position and a fully-open position, the closure panel having an interior surface (23) adjacent to an edge (17), the edge defining a transition between the interior surface and an exterior surface (21) of a panel body (27) of the closure panel; and
a flap (26) positioned on the motor vehicle adjacent to the edge while being off of and separate to the panel body of the closure panel, such that the interior surface (23) is accessible once the flap is operated.

2. The closure panel system of claim 1, the closure panel further having at least one of a handle (24) and a door switch (62) mounted on the interior surface adjacent to an edge (17), such that the at least one of the handle and the door switch is accessible once the cover flap is operated, wherein a latch assembly (20) mounted on the closure panel is operated by the at least one of the handle and the door switch.

3. The closure panel system of claim 1, wherein the flap covers a recess volume (83) of the motor vehicle adjacent to at least one of a handle and a door switch.

4. The closure panel system of claim 3, wherein the flap and the recess volume are positioned on a second closure panel of the motor vehicle adjacent to the closure panel.

5. The closure panel system of claim 3, wherein the flap and the recess volume are positioned on the body of the motor vehicle adjacent to the closure panel.

6. The closure panel system of claim 2 further comprising a presentment mechanism (22) mounted in the panel body for presenting the closure panel from the closed position upon operation of the latch assembly.

7. The closure panel system of claim 1 further comprising an actuator assembly (108) coupled to the flap for actuating the flap from a closed position to an open position, the open position providing access to the interior surface for a user.

8. The closure panel system of claim 3 further comprising a light source (123) mounted in the recess volume in order to illuminate the recess volume upon operation of the flap.

9. The closure panel system of claim 4, wherein the flap has an exterior surface (99) positioned flush with an exterior surface (21) of the second closure panel.

10. The closure panel system of claim 5, wherein the flap has an exterior flap surface (99) positioned flush with an exterior body surface (30a) of the body.

11. A closure panel system for a motor vehicle comprising:
a closure panel mounted to a vehicle body for movement between a closed position and a fully-open position, the closure panel having an interior surface and an edge, the edge defining a transition between the interior surface and an exterior surface of a panel body of the closure panel; and
a flap positioned on the closure panel adjacent to the edge on the exterior surface, such that the interior surface is accessible once the cover flap is operated.

12. The closure panel system of claim 11, wherein the flap covers a recess volume of the panel body adjacent to the interior surface.

13. The closure panel system of claim 11, with the interior surface has at least one of a handle and a door switch mounted on the interior surface adjacent to the edge.

14. The closure panel system of claim 13, wherein a latch assembly is mounted on the closure panel and is operated by the at least one of the handle and the door switch, the closure panel system further comprising a presentment mechanism mounted in the panel body for presenting the closure panel from the closed position upon operation of the latch assembly.

15. The closure panel system of claim 11 further comprising an actuator assembly coupled to the flap for actuating the flap from a closed position to an open position, the open position providing access to the interior surface for a user.

16. The closure panel system of claim 12 further comprising a light source mounted in the recess volume in order to illuminate the recess volume upon operation of the flap.

17. The closure panel system of claim 11, wherein the flap has an exterior flap surface positioned flush with the exterior surface of the closure panel.

18. A method for operating a closure panel system for a closure panel mounted to a motor vehicle for movement between a closed position and a fully-open position, the method comprising the steps of:
detecting a user approaching the closure panel;
actuating a flap to an open position in order to expose an interior surface of the closure panel to the user, the flap positioned either:
a) on the motor vehicle adjacent to an edge of the closure panel while being off of and separate to a panel body of the closure panel; or
b) on the closure panel adjacent to the edge on an exterior surface of the closure panel,
such that the interior surface is accessible once the cover flap is operated.

19. The method of claim 18, wherein the flap covers a recess volume adjacent to the interior surface, and further comprising the step of operating a light source in order to illuminate the recess volume.

20. The method of claim 18, further comprising the step of operating a presentment mechanism in order to present the closure panel to the user.
